(19) United States
(12) Patent Application Publication
(10) Pub. No.: US 2005/0194881 A1
(43) Pub. Date: Sep. 8, 2005

(54) Flat panel display device and method for making the same

(76) Inventors: Joong-Woo Nam, Suwon-si (KR); Tae-Ill Yoon, Suwon-si (KR); Jong-Hwan Park, Suwon-si (KR); Chun-Gyoo Lee, Suwon-si (KR); Deok-Hyeon Choe, Suwon-si (KR); Ji-Beom Yoo, Seongnam-si (KR); Jong-Hyung Choi, Seoul (KR)

Correspondence Address: CHRISTIE, PARKER & HALE, LLP, PO BOX 7068, PASADENA, CA, 91109-7068, US

(21) Appl. No.: 11/070,389

(22) Filed: Mar. 2, 2005

(30) Foreign Application Priority Data
Mar. 3, 2004 (KR) 10-2004-0014256

(51) Int. Cl. H01J 1/05

(52) U.S. Cl. 313/311

(57) ABSTRACT

Disclosed is a method for a making cathode substrate for a flat panel display device including coating a cathode electrode composition on a substrate to produce a cathode electrode, coating a conductive composition including a Si-included material on the cathode electrode to prepare a conductive layer on the cathode electrode and applying an electron emission composition including a material such as carbon nano tube on the conductive layer.

### CROSS REFERENCE TO RELATED APPLICATION

This application claims priority to and the benefit of Korean Patent Application No. 10-20040014256 filed on Mar. 3, 2004 in the Korean Intellectual Property Office, the entire content of which is incorporated herein by reference.

### FIELD OF THE INVENTION

The present invention relates to a method for making a cathode assembly for a flat panel display device and a flat panel display device comprising the cathode assembly, and more particularly, to a method for making a cathode assembly for a flat panel display device on which an electron emission region is formed by a simplified process without additional surface treatment steps. It further relates to a flat panel display device comprising the electron emission region formed by the above-mentioned method.

### BACKGROUND OF THE INVENTION

A flat panel display device is generally composed of two substrates; that is, a cathode region to emit electrons and anode region to emit light by the electrons emitted from the cathode region. The substrates are arranged to display a predetermined image.

According to the basic structure of a flat panel display device, an electron emission display is fabricated by arraying a pair of substrates, that is, a cathode substrate on which an electron emission region is formed as a cold-cathode electron source, and an anode substrate on which green, blue, and red phosphor screens are formed with a pattern defined by black layers. The phosphors are excited by the electrons emitted by the cathode substrate and produce colored light.

This flat panel display device uses a spindt-type emitter at an electron emission region, wherein a pointed tip is used, laminated with such materials as molybdenum or silicon. This spindt-type electron emitter has hyper-minute structures, so its manufacturing process demands extremely complicated methods and highly-precise techniques such that it is hard to make a large-sized display device.

Carbonaceous materials have recently emerged as potentially useful electron emission source due to their low work function. One carbonaceous material, a carbon nano tube (CNT), is particularly expected to be an ideal electron emission source since it features a high aspect ratio and a small tip radius of curvature of 100 Å, and thereby electrons are readily emitted by applying an external voltage of as low as 1˜3 V/μm.

There are generally two methods for forming an electron emission region with Carbon Nano Tubes (CNTs): a screen-printing procedure and a chemical vapor deposition (CVD) procedure. The screen printing procedure is performed by forming a paste of carbon nano tubes, graphite, resin, and solvent, screen-printing the paste, and sintering it. However, this method has some disadvantages, in that it is difficult to prepare an appropriate paste. Furthermore, it generally requires an additional surface treatment step of the electron emission source after the sintering process.

On the other hand, CVD is performed by directly growing the cathode material on the desired position after fabrication of the flat panel display device. However, in this method it is difficult to form a uniform electron emission region for a large-sized display.

### SUMMARY OF THE INVENTION

In one embodiment of the present invention, a method for fabricating a cathode assembly for a flat panel display device is provided in which the adhesive force between the electron emission region and the substrate increases and an additional surface treatment step is not necessary.

In another embodiment of the present invention, a flat panel display device is provided including the cathode assembly fabricated by the above method.

According to one embodiment of the present invention, the method of fabricating a cathode assembly for a flat panel display device includes forming a cathode electrode on a substrate; coating a conductive composition including a Si-containing material on the cathode electrode to prepare a conductive layer; and coating an electron emission composition including carbon nano tube on the conductive layer.

A flat panel display device of the present invention includes a substrate, a cathode electrode on the substrate, a conductive layer including a Si-containing material on the cathode electrode, and an electron emission region on the conductive layer.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, wherein:

FIG. 1 is a process flow chart showing a process for fabricating a cathode assembly for a flat panel display device, according to one embodiment of the present invention; and

FIG. 2 is a graph showing electron emission properties on the cathode assembly according to Example 1 of the present invention compared to Comparative Example 1.

### DETAILED DESCRIPTION

The present invention relates to a method for fabricating a cathode assembly for a flat panel display device, whose general process is simpler than prior processes. In addition, this method does not require an additional surface treatment step because an electron emission region forms on the external surface of the cathode assembly. Use of this method increases the adhesive force between the electron emission region and the substrate.

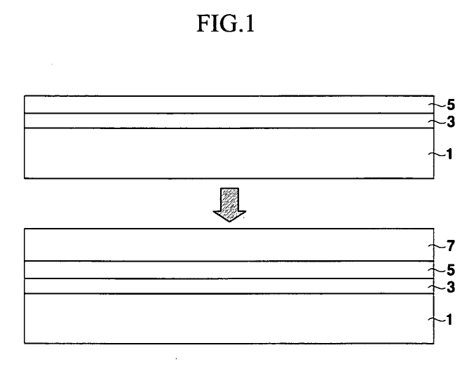

A method of fabricating the cathode assembly of the present invention is explained with reference to FIG. 1. First, a cathode electrode 3 is formed on a substrate 1. The cathode electrode may be formed by using such materials as Ag-paste, indium tin oxide (ITO), etc., or a thin metal layer such as Cr or Mo, etc. Photo lithographic or thick-film printing is selectively employed to make this cathode electrode, depending on what material is used.

A conductive composition including a Si-containing material is coated on the cathode electrode 3 to form a conductive layer 5. This conductive layer enhances the adhesion between the cathode electrode and an electron emission region, and minimizes the amount of residual organic material after sintering. This results in increased durability.

The conductive compounds used here include Si compounds, for example, methyl siloxane polymer (Si—O—CH₃) or a compound represented by Formula 1. 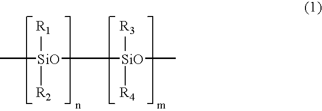
where R₁, R₂, R₃, and R₄ are the same or independently selected from linear or branched alkyl, cycloalkyl, alkenyl, aryl, aralkyl, alkyl halide, aryl halide, aralkyl halide, phenyl, mercaptan, methacrylate, acrylate, epoxy, or vinyl ether; wherein the alkyl has from 1 to 18 carbons, the cycloalkyl has from 3 to 18 carbons, the alkenyl has from 2 to 18 carbons, and the aralkyl has from 6 to 18 carbons; and n and m are the same or different, and are integers between 1 and 100,000.

The conductive composition includes 12 to 17 wt % of a Si-containing material, 11 to 19 wt % of acetone, 28 to 36 wt % of ethyl alcohol, 25 to 35 wt % of isopropanol, and the balance of water.

The conductive composition further includes a conductive metal such as Ag, Al, Ni, Co, or Cu. The coating step for preparing the conductive layer is performed by a general coating process, for example, spin coating, screen printing, or spray method. The conductive metal is preferably provided in an amount from 0.01 to 50 parts by weight based on 100 parts by weight of the total weight of the conductive composition. Thus, the conductive layer includes the conductive metal in an amount of 0.01 to 50 wt %. If the amount of the conductive metal is out of the range, the effect by the conductive metal is higher than that by an electron emission material and it is difficult to form an electron emission region on an external surface.

Next, an electron emission composition including an electron emission material is coated on the conductive layer 5 to form an electron emission region 7. The electron emission material may be any material as long as it emits electrons. Exemplary materials are Carbon Nano Tubes, graphite, carbon, or diamond-like carbon. The process to form the electron emission region may be performed by a process such as air spreading, spin coating, screen printing, or a spray process. The amount of the electron emission materials in the electron emission compounds is preferably from 0.01 to 50 wt %. If the amount of the electron emission material is less than 0.01 wt %, it is difficult to emit electrons. If the amount is more than 50 wt %, the surface of the electron emission region is not uniformly formed.

The electron emission composition also includes vehicles for improving the properties of the composition such as to control the viscosity and density of the composition so it can print easily. Exemplary materials used in the paste compositions as vehicles include thickeners, binders, and solvents.

A thickener is used to enhance the adhesive force between layers, and it may include silicone-based materials, or mineral oil such as terpineol. The binder may include organic resins such as ethyl cellulose, acryl resin, or epoxy resin. The solvent may include butyl carbitol acetate, terpineol, ethyl cellulose, ethyl carbitol, or any organic solvent such as animal oil or vegetable oil.

As the vehicle facilitates the printing of the paste composition, it should be completely removed by evaporation during sintering of the printed substrate. Consequently, referring again to FIG. 1, after sintering, the resulting electron emission region 7 is thinner than after it was first applied to the conductive layer. The amount of the vehicle or vehicles in the electron emission composition is adjusted depending on the amount of the main materials such as carbon nano tubes, but it is not particularly limited.

The flat panel display device fabricated according to this method includes a substrate, a cathode electrode formed on the substrate, a conductive layer including a Si-containing material, and an electron emission region layer formed on the conductive layer.

Advantageous examples and comparative examples are as below. However, the examples here do not represent all possible advantageous embodiments of the present invention.

### EXAMPLE 1

A cathode electrode composition with indium tin oxide was coated on a glass substrate to produce a cathode electrode. A conductive layer composition including 15 wt % of methyl siloxane polymer, 17 wt % of acetone, 32 wt % of ethyl alcohol, 30 wt % of isopropanol and the balance of water was coated on the cathode electrode to form a conductive layer.

Carbon nano tubes were mixed with a terpineol solvent to prepare an electron emission composition and the composition was coated on the conductive layer, thereby producing a cathode assembly with the substrate, the conductive layer, and the electron emission region.

### COMPARATIVE EXAMPLE 1

A cathode assembly was prepared according to Example 1 except that the conductive layer was omitted.

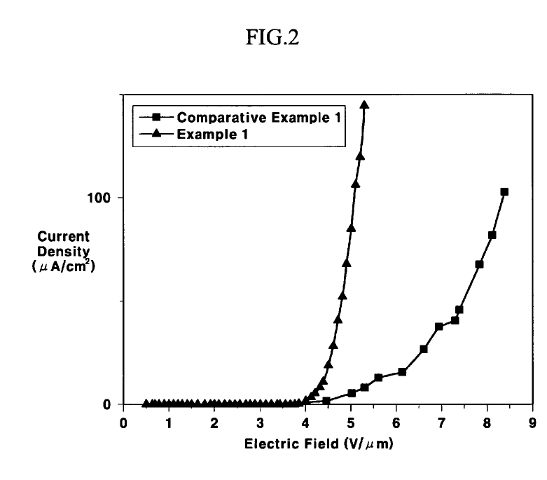

The electron emission properties of the cathode assemblies according to Example 1 and Comparative Example 1 were measured. The results are presented in FIG. 2. It is shown from FIG. 2 that the cathode assembly according to Example 1 emitted electrons at a lower voltage compared with that according to Comparative Example 1.

The method for fabricating-a-cathode assembly for a flat panel display device of the present invention more simply fabricates an electron emission region without additional surface treatment, increasing the adhesive force between the substrate and the electron emission region, and improving the durability by minimizing the amount of residual organic materials after sintering.

1. A method for fabricating a cathode assembly for a flat panel display device, comprising:
(a) forming a cathode electrode on a substrate;
(b) coating a conductive composition comprising a Si-containing material on the cathode electrode to form a conductive layer on the cathode electrode; and
(c) coating an electron emission composition on the conductive layer.

2. The method for fabricating a cathode assembly for the flat panel display device according to claim 1, wherein the Si-containing material is SiOCH₃.

3. The method for fabricating a cathode assembly for a flat panel display device according to claim 2, wherein the conductive composition comprises from 12 to 17 wt % of SiOCH₃, from 11 to 19 wt % of acetone and from 25 to 25 wt % of isopropanol.

4. The method for fabricating a cathode assembly for a flat panel display device according to claim 1, wherein the conductive composition further comprises a conductive metal.

5. The method for fabricating a cathode assembly for a flat panel display device according to claim 4, wherein the conductive metal is selected from the group consisting of Ag, Al, Ni, Co, Cu and combinations thereof.

6. The method for fabricating a cathode assembly for a flat panel display device according to claim 1, wherein the coating of the conductive composition is performed by a method selected from spin-coating, screen-printing, and a spray method.

7. The method for fabricating a cathode assembly for a flat panel display device according to claim 1, wherein the electron emission composition comprises a material selected from the group consisting of carbon nano tubes, graphite, carbon, and diamond-like carbon.

8. The method for fabricating a cathode assembly for a flat panel display device according to claim 1, wherein the coating step of the electron emission composition is performed by a method selected from air-spreading, spin-coating, screen-printing, and a spray method.

9. The method for fabricating a cathode assembly for the flat panel display device according to claim 1, wherein the Si-containing material is represented by the following formula: 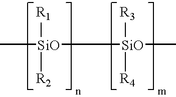
where R₁, R₂, R₃, and R₄ are the same or independently selected from linear or branched alkyl, cycloalkyl, alkenyl, aryl, aralkyl, alkyl halide, aryl halide, aralkyl halide, phenyl, mercaptan, methacrylate, acrylate, epoxy, or vinyl ether radicals with up to 18 carbons; and n and m are the same or different, and are integers between 1 and 100,000.

10. A flat panel display device comprising:
a substrate;
a cathode electrode on the substrate;
a conductive layer comprising a Si-containing material; and
an electron emission region layer on the conductive layer.

11. The flat panel display device according to claim 10, wherein the Si-containing material is selected from the group consisting of SiOCH₃ and a compound represented by the following formula: 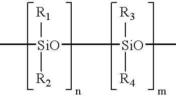
where R₁, R₂, R₃, and R₄ are the same or independently selected from linear or branched alkyl, cycloalkyl, alkenyl, aryl, aralkyl, alkyl halide, aryl halide, aralkyl halide, phenyl, mercaptan, methacrylate, acrylate, epoxy, or vinyl ether radicals with up to 18 carbons; and n and m are the same or different, and are integers between 1 and 100,000.

12. The flat panel display device according to claim 11, wherein the conductive layer comprises from 12 to 17 wt % of the Si-containing material, from 11 to 19 wt % of acetone, and from 25 to 25 wt % of isopropanol.

13. The flat panel display device according to claim 10 wherein the conductive layer further includes a conductive metal.

14. The flat panel display device according to claim 13, wherein the conductive metal is selected from the group consisting of Ag, Al, Ni, Co, Cu and combinations thereof.

15. The flat panel display device according to claim 13, wherein the conductive metal is provided in an amount from 0.01 to 50 weight %.

16. The flat panel display device according to claim 10, wherein the conductive layer is formed by a process selected from spin-coating, screen-printing, and a spray process.

17. The flat panel display device according to claim 10, wherein the electron emission region layer comprises a material selected from the group consisting of carbon nano tube, graphite, carbon, and diamond-like carbon.

18. The flat panel display device according to claim 10, wherein the electron emission region layer is formed by a process selected from air spreading, spin-coating, screen-printing, and a spray process.

19. The flat panel display device according to claim 10, wherein the electron emission region layer includes an electron emission material provided in an amount of 0.01 to 50 wt %.
